(19) United States
(12) Patent Application Publication
(10) Pub. No.: US 2026/0027507 A1
(43) Pub. Date: Jan. 29, 2026

(54) A BINDER LESS NA-LSX ZEOLITE SYNTHESIS FOR HIGHER N2 ADSORPTION

(71) Applicant: COUNCIL OF SCIENTIFIC AND INDUSTRIAL RESEARCH, New Delhi (IN)

(72) Inventors: Vijay Vasant BOKADE, Pune (IN); Prashant Suresh NIPHADKAR, Pune (IN)

(73) Assignee: COUNCIL OF SCIENTIFIC AND INDUSTRIAL RESEARCH, New Delhi (IN)

(21) Appl. No.: 19/099,908

(22) PCT Filed: Jul. 27, 2023
(86) PCT No.: PCT/IN2023/050718

§ 371 Date: Jan. 30, 2025

(30) Foreign Application Priority Data
Aug. 1, 2022 (IN) 202211044092

(51) Int. Cl. B01D 53/02; B01J 20/18; B01J 20/28; B01J 20/30; C01B 39/22

(52) U.S. Cl. CPC B01D 53/02; B01J 20/186; B01J 20/28019; B01J 20/3085; C01B 39/22; B01D 2253/108; B01D 2257/102; B01D 2258/06; C01P 2002/72

(57) ABSTRACT

The present invention relates to a process for the synthesis of binder-less Na-LSX zeolite without gel ageing, which shows higher N₂ adsorption from air, which contains 21% N₂ and 79% O₂.

### FIELD OF THE INVENTION

The present invention relates to a binderless Na-LSX zeolite for higher N₂ adsorption. Particularly, the present invention relates to a process for the synthesis of binderless Na-LSX zeolite without gel ageing, which shows higher N₂ adsorption from air, which contains 21% O₂ and 79% N₂.

### BACKGROUND AND PRIOR ART OF THE INVENTION

Separation of nitrogen by adsorption technique from the admixture of different gases is very important process among all industrial processes. Nitrogen is separated in order to obtain either nitrogen rich product or nitrogen less product.

Several techniques such as cryogenic distillation, pressure swing adsorption (PSA), vapour pressure swing adsorption (VPSA) are available in the prior art for the N₂ adsorption. Out of which, use of zeolites for the separation/adsorption of N₂ is widely used technique. Zeolites due to their high adsorbing efficiency are used for the adsorption of different gases like CO₂, O₂, N₂ and even oily/liquid materials from different mixtures. Different ratio of zeolite composition and their physical form play a vital role in their adsorbing efficiency. Hence, their appropriate manufacturing is also became a very important and interesting research topic for scientists.

An article entitled “Synthesis and characterization of NaX-type zeolites prepared by different silica and alumina sources and their CO₂ adsorption properties” by K. Chayakul Chanapattharapol et al. and published in the journal “Microporous and Mesoporous Materials 310 (2021) 110632” reported synthesis of zeolites by using two pairs of silicon and aluminium sources (sodium silicate solution+Al(OH)₃ and sodium silicate powder+sodium aluminate). The article indicated that sodium silicate and sodium aluminate sources yielded zeolite with high surface area and pore volume. CO₂ adsorption capacity and selectivity of zeolite NaX was modified by using Cetyltrimethylammonium bromide (CTAB) and heptane. The surface area and pore volume of zeolite products increased due to smaller crystalline size and then resulted in significant enhancement of CO₂ uptake of the synthesized zeolite NaX. The article also showed that the role of additives on zeolite formation was to increase the nuclei formation rate and number which gave rise to smaller zeolite crystals.

One more article “Effects of Na and K ions on the Crystallization of Low-silica X Zeolite and its Catalytic Performance for Alkylation of Toluene with Methanol” by Kan Zhang et al. and published in the journal “J. Braz. Chem. Soc., Vol. 25, No. 1, 65-74, 2014” indicated that in the synthesis of LSX, the molar ratio of K/(Na+K) affects the crystallization and the composition of final products. A higher mole fraction of K corresponded to a lower crystallization rate, higher concentration of Si in the liquid phase, and lower Si/Al ratio of the obtained LSX. The average size of LSX products steadily increased with the progressive replacement of Na by K in the initial gels, and crystal morphology of the LSX products gradually changed from round to octahedral. Another article entitled “Synthesis and Characterization of High Aluminum Zeolite X from Technical Grade Materials” by Seyed Kamal Masoudian et al. and published in the journal “Bulletin of Chemical Reaction Engineering & Catalysis, 8(1), 2013, 54-60” reported a preparation of high aluminum zeolite X from mixing technical grade sodium aluminate and sodium silicate solutions at temperatures between 70° C. and 100° C. The synthesized zeolite X was characterized by SEM and X-ray methods according to ASTM standard procedures. The results showed that aging of the synthesis medium at the room temperature considerably increased the selectivity of zeolite X formation. On the other hand, high temperature of reaction mixture during crystallization formed zeolite A in the product; therefore, it decreased the purity of zeolite X. In addition, it was found that increasing H2O/Na2O and decreasing Na2O/SiO2 molar ratios in the reaction mixture resulted product with higher purity.

One of US published patent document U.S. Pat. No. 9,061,918B2 reports a zeolite of the faujasite X type having a low silica content, more precisely a zeolite LSX having a Si/Al atomic ratio lower than or equal to 1.15, having a high crystallinity rate and whereof the crystals have a controlled particle size distribution, wherein the molar composition is: Na2O/(Na2O+K2O) ratio of 0.75 to 1; SiO2/Al2O3 of 1.8 to 2.2; (Na2O+K2O)/Al2O3, of 4.8 to 6; H2O/Al2O3 of 60 to 85. However, the molar gel composition and way of addition of salts as covered in this US patent are different than the present application, and not preferable at all considering they produce sodalite and other Na or K based impurities, hence, provides only upto 95% crystallinity (and not upto 100% which is desirable).

Therefore, thus it is found that still there is a need in the art to develop a process for the manufacturing of zeolites materials which can be used effectively for the separation and adsorption of different gases.

### OBJECTIVES OF THE INVENTION

The main objective of the present invention is to provide a binderless Na-LSX zeolite for higher N₂ adsorption.

Another objective of the present invention is to provide a process for the synthesis of binderless Na-LSX zeolite for higher N₂ adsorption.

Yet another objective of the present invention is that a binderless Na-LSX zeolite is applicable in a N₂ adsorption from air by PSA/VPSA techniques.

Yet another objective of the present invention is that a process for adsorption of N₂ from air using said binderless Na-LSX zeolite by PSA/VPSA techniques.

### SUMMARY OF THE INVENTION

Accordingly, to accomplish the objectives, the present invention provides a binderless Na-LSX zeolite for higher N₂ adsorption.

In an embodiment, the present invention provides a binderless Na-LSX zeolite for higher N₂ adsorption, wherein the molar gel composition of said zeolite is SiO₂/Al₂O₃=2.0; (Na₂O+K₂O)/SiO₂=3.0; Na₂O/Na₂O+K₂O=0.77; H₂O/Na₂O+K₂O=25 with 100% crystallization.

Another embodiment of the present invention provides a process for the synthesis of a NaK-LSX zeolite in powder form and Na-LSX zeolite in powder form, wherein said process comprises the steps of:
(a) adding solution A (prepared by dissolving 0.896 kg Sodium aluminate in 2.8L water under continuous stirring and continued stirring till the complete dissolution of Sodium aluminate) to solution B (prepared by dissolving 1.135 kg of NaOH in 4.1 L water under constant stirring) rapidly under stirring at a temperature in the range of 70-75° C. (temperature of solution B) for a period of 5 minutes;
(b) preparing solution C by adding sodium silicate solution (2.07 kg) in 4.1 kg water and then adding solution C slowly to a mixture of a solution of A and B obtained at step (a) under vigorous stirring at a temperature in the range of 30-40° C. for a period of 60 minutes under continuous vigorous stirring;
(c) adding solution D (prepared by adding 0.878 kg KOH in 0.8 L water), into a mixture obtained at step (b) under vigorous stirring at a temperature in the range of 30-40° C. for a period in the range of 1-2 hour;
(d) transferring the obtained gel at step (c) into a 20L SS autoclave and crystallizing out at 70-75° C. for 17 h;
(e) filtering and washing with demineralized water till Na and K removal and drying at 100° C. for 12 h to obtain NaK LSX zeolite in powder form (confirmed by X-ray diffraction as pure faujasite type zeolite (NaK-LSX));
(f) subjecting the NaK-LSX thus obtained further for ion exchange using 2 M Sodium chloride solution (in the proportion 10 ml per gram of solid) at pH=9-10 at 95° C. for 5 h; and
(g) washing the excess salt with deionized water to remove chloride ions from the solid obtained at step f) and drying the solid at 110° C. for 12 to afford Na-LSX zeolite in powder form.

Another aspect of an embodiment is to provide a process for the preparation of a Na-LSX zeolite in extrudates form, sphere form, tablet form. Specifically, the present invention discloses a process for the preparation of a binderless Na-LSX zeolite in extrudates form, sphere form, tablet form by converting binder (such as Kaolin Clay, etc.) containing Na-LSX zeolite extrudates/sphere/tablet into zeolite, wherein said process comprises the steps of:
A) mixing 70 g of Zeolite X powder (Na-LSX), 30 g of kaolin (initial material 4) and 2 g of a Lactose;
B) preparing a dough of proper consistency of the above mixture obtained at step (A) the dough is prepared in a twin-shaft mixer using 45 gm of the sodium salt of carboxymethyl cellulose solution (2.5 wt %);
C) shaping the above dough mixture obtained at step (B) subsequently into 1 millimetre-sized extrudate in a screw extruder Machine (V J instrument);
D) cutting the extrudate as obtained at step (C) after extrusion, into a length of 2 to 5 mm, and drying at 110° C. for 12 h and then annealing at 600° C. for 4 h;
E) processing the Na-LSX extrudate further in a spheronization machine to make it Na-LSX sphere or tablet;
F) soaking the 10 g extrudates/sphere/tablet in 100 ml of deionized water for 60 min;
G) decanting the water largely after the predetermined time from the reaction material obtained at step F) and replacing by a solution Z (reaction solution consist of 100 ml deionized water and 2 gm NaOH flasks);
H) ageing the soaked extrudate in the solution obtained at step (G) for 1 hours at a temperature in the range of 25-35° C.;
I) heating the reaction mixture obtained at step (H) to a temperature in the range of 80-85° C. and maintaining at 80-85° C. for 17 h; and
J) cooling the reaction material obtained at step (I) and decanting the supernatant solution and washing three times with 100 ml of deionized water, filtering and drying at 100° C. to obtain the binderless Na-LSX zeolite in extrudates/sphere/tablet form. (The material produced in this manner exhibits a crystallinity of 95% (XRD) based on the initial zeolite powder).

Another embodiment of the present invention is that a binderless Na-LSX zeolite is applicable in N₂ adsorption.

### BRIEF DESCRIPTION OF THE DRAWINGS

FIG. 1: Powder XRD pattern of the 1a) NaK LSX zeolite in powder form, 1b) Na-LSX zeolite in powder form, 1c) Na-LSX zeolite in extrudates form, sphere form, tablet form (1 mm), 1d) Binderless Na-LSX Extrudates/sphere/tablet (1 mm), and 1e) commercial sample (x-axis: 2θ and y-axis: intensity).

FIG. 2: N₂ Adsorption of Na-LSX Powder (9.39 ml/g)

FIG. 3: N₂ Adsorption of Binderless Na-LSX Extrudates/sphere (1 mm) (9.34 ml/g)

FIG. 4: N₂ adsorption over Ca exchanged-LSX Extrudates/sphere (CaLSX) (N₂ adsorption—19.52 ml/g)

FIG. 5: N₂ adsorption over Li exchanged-LSX Extrudates/sphere (LiLSX) (N₂ adsorption—21.92 ml/g)

### ABBREVIATIONS AND DEFINITIONS

Zeolite: The term “zeolite” may be defined as “any of a large group of minerals consisting of hydrated aluminosilicates of sodium, potassium, calcium, or barium, and they can be readily dehydrated and rehydrated, and are generally used as cation exchangers and molecular sieves”
Binderless process: The process involves converting binder into zeolite, making granules without binder
Extrudate: Converting zeolite powder into extrudate shape by adding binder
13X or NaX zeolite or phase: Sodium form of X-type zeolite
LSX zeolite: Low Silica X-type zeolite
Na: Sodium
K: Potassium
NaK-LSX: Sodium-potassium based LSX zeolite
N₂: Nitrogen
Ca: Calcium
Li: Lithium
SiO₂: Silicon dioxide
Al₂O₃: Aluminium trioxide
Na₂O: Sodium oxide
K₂O: Potsassium oxide
NaOH: Sodium hydroxide

### DETAILED DESCRIPTION OF THE INVENTION

It is to be understood that the figures and descriptions of the present invention have been simplified to illustrate elements that are relevant for a clear understanding of the invention. The detailed description will be provided herein below with reference to the attached drawing.

The term “adsorption capacity” used herein in the specification means the nitrogen adsorption capacity.

The present invention provides a binderless Na-LSX zeolite for higher N₂ adsorption.

In an embodiment, the present invention provides a binderless Na-LSX zeolite for higher N₂ adsorption, wherein the molar gel composition of said zeolite is SiO₂/Al₂O₃=2.0; (Na₂O+K₂O)/SiO₂=3.0; Na₂O/Na₂O+K₂O=0.77; H₂O/Na₂O+K₂O=25 with 100% crystallization.

In another embodiment, the present invention relates to a binderless zeolite for higher N₂ adsorption, comprising sodium LSX, wherein a molar gel composition of said binderless zeolite comprises SiO₂, Al₂O₃, Na₂O, K₂O, and H₂O with ratio of 1.9:0.9:4.52:1.28:140 to 2.1:1.1:4.72:1.48:150, and wherein a molar concentration of said binderless zeolite comprises SiO₂/Al₂O₃=1.9 to 2.1; (Na₂O+K₂O)/SiO₂=2.9 to 3.1; Na₂O/(Na₂O+K₂O)=0.67 to 0.87; and H2O/(Na₂O+K₂O)=24 to 26.

In another embodiment, the ratio of molar gel composition of said binderless zeolite is 2:1:4.62:1.3:150.

In another embodiment, the molar concentration of said binderless zeolite comprises SiO₂/Al₂O₃=2.0; (Na₂O+K₂O)/SiO₂=3.0; Na₂O/(Na₂O+K₂O)=0.77; and H2O/(Na₂O+K₂O)=25.

In another embodiment, said binderless Na-LSX zeolite has a 100% crystallinity of pure 13X phase or NaX phase.

Said molar gel composition is very critical and important to have an optimum gel required to get pure Na-LSX phase, without giving out impurities such as Na-A, Sodalite and zeolite P etc., and that to without gel ageing.

Another embodiment of the present invention provides a process for the synthesis of a NaK LSX zeolite in powder form, wherein said process comprises the steps of:
(a) adding a solution A (prepared by dissolving 0.896 kg Sodium aluminate in 2.8L water under continuous stirring and continued stirring till the complete dissolution of Sodium aluminate) to solution B (prepared by dissolving 1.135 kg of NaOH in 4.1 L water under constant stirring) rapidly under stirring at a temperature in the range of 70-75° C. (temperature of solution B) for a period of 5 minutes;
(b) preparing solution C by adding sodium silicate solution (2.07 kg) in 4.1 kg water and then adding solution C slowly to a mixture of solution of A and solution B obtained at step (a) under vigorous stirring at a temperature in the range of 30-40° C. for a period of 60 minutes under continuous vigorous stirring;
(c) adding solution D (prepared by adding 0.878 kg KOH in 0.8 L water), into a mixture obtained at step (b) under vigorous stirring at a temperature in the range of 30-40° C. for a period in the range of 1-2 hour;
(d) transferring the obtained gel at step (c) into a 20L SS autoclave and crystallizing the gel at 70-75° C. for 17 h;
(e) filtering and washing the crystallized gel obtained in step d) with demineralized water till Na and K removal and drying at 100° C. for 12 h. (confirmed by X-ray diffraction as pure faujasite type zeolite (NaK-LSX)).

The present invention further provides a process for the conversion of a NaK-LSX to Na-LSX zeolite in powder form, wherein said process comprises the steps of:
i) subjecting the NaK-LSX thus obtained further for ion exchange using 2 M Sodium chloride solution (in the proportion 10 ml per gram of solid) at pH=9-10 at 95° C. for 5 h; and
ii) washing the excess salt with deionized water to remove chloride ions from the solid obtained at step i), and drying the solid at 110° C. for 12 h to afford Na-LSX.

In another embodiment, the present invention provides a process of synthesis of a NaK-LSX zeolite and Na-LSX zeolite in a powder form, wherein said process comprises the steps of:
(a) adding a solution A of sodium aluminate in water, into a solution B of sodium hydroxide in water, rapidly under stirring of 220-280 rpm at a temperature in the range of 70-75° C. for a period of 3 to 8 minutes;
(b) preparing a solution C of sodium silicate in water, and then adding said solution C slowly into a mixture of solution A and solution B as obtained in step (a) under rapid stirring of 220-280 rpm at a temperature in the range of 30-40° C. for a period of 40 to 80 minutes;
(c) adding solution D of KOH in water, into a mixture obtained in step (b) under vigorous stirring at a temperature in the range of 30-40° C. for a period in the range of 1-2 hrs to obtain a gel;
(d) transferring the gel obtained in step (c) into an autoclave followed by crystallizing the gel at a temperature in the range of 70-75° C. for a time period in the range of 15-19 hrs;
(e) filtering the crystallized gel obtained in step d) followed by washing with demineralized water till Na and K removal, and then drying at temperature in the range of 90-110° C. for time period in the range of 10-14 hrs to obtain a NaK-LSX zeolite in a powder form;
(f) subjecting the NaK-LSX zeolite powder form of step e) for an ion exchange step at a pH of 9-10 at a temperature in the range of 90-100° C. for a time period in the range of 4-6 hours to obtain an ion exchanged zeolite; and
(g) washing the ion exchanged zeolite of step f) with deionized water to remove excess salt and chloride ions, followed by drying at a temperature in the range of 100-120° C. for a time period of 10-14 hrs to obtain the Na-LSX zeolite in the powder form.

In another embodiment, the stirring mentioned in above step is preferably 250 rpm.

In another embodiment, the solution A is prepared by dissolving 0.5 to 2 kg of sodium aluminate in 2 to 6L of water under continuous stirring of 220-280 rpm till the complete dissolution of said sodium aluminate.

In a preferred embodiment, the solution A is prepared by dissolving 0.896 kg of sodium aluminate in 2.8L of water under continuous stirring of 250 rpm till the complete dissolution of said sodium aluminate.

In another embodiment, the solution B is prepared by dissolving a 1.5 to 4 kg of NaOH in 3.5 to 7 L of water under constant stirring of 220-280 rpm at a temperature in the range of 70-75° C.

In a preferred embodiment, the solution B is prepared by dissolving a 1.135 kg of NaOH in 4.1 L of water under constant stirring of 250 rpm at a temperature in the range of 70-75° C.

In another embodiment, the solution C is prepared by adding 1.5 to 3 kg of sodium silicate in 3.5 to 7 kg of water under stirring of 220 to 280 rpm.

In a preferred embodiment, the solution C is prepared by adding 2.07 kg of sodium silicate in 4.1 kg of water under stirring of 250 rpm.

In another embodiment, the solution D is prepared by adding 0.5 to 2 kg of KOH in 0.5 to 3 L of water under stirring of 220 to 280 rpm.

In a preferred embodiment, the solution D is prepared by adding 0.878 kg of KOH in 0.8 L of water under stirring of 250 rpm.

In another embodiment, the ion exchange process step is done using 0.5 to 4 M of sodium chloride solution in the proportion of 10 ml per gram of solid.

In a preferred embodiment, the ion exchange process step is done using 2 M of sodium chloride solution in the proportion of 10 ml per gram of solid.

Another embodiment of the present invention is to provide a process for the preparation of a Na-LSX zeolite in extrudates form (cylindrical shape), sphere form (spherical shape), tablet (pellet shape) form, wherein said process comprises the steps of:
A) mixing 70 g of Zeolite X powder (Na-LSX), 30 g of kaolin (initial material 4) and 2 g of a Lactose;
B) preparing a dough of proper consistency of above mixture obtained at step (A) was in a twin-shaft mixer using 45 gm of the sodium salt of carboxymethyl cellulose solution (2.5 wt %);
C) shaping the above dough mixture obtained at step (B) subsequently into 1 millimetre-sized extrudate in a screw extruder Machine (V J instrument);
D) cutting the mixture obtained at step (C) after extrusion, into a length of 2 to 5 mm, and drying at 110° C. for 12 h and then annealing at 600° C. for 4 h;
E) processing the extrudate further in spheroniztion machine to make it sphere or tablet.

The present invention further provides a process for the preparation of a binderless Na-LSX zeolite in extrudates form, sphere form, tablet form, wherein said process comprises the steps of:
I) soaking the 10 g extrudates/sphere/tablet in 100 ml of deionized water for 60 min;
II) decanting the water largely after the predetermined time from the reaction material obtained at step I) and replacing by the reaction solution (reaction solution consist of 100 ml deionized water and 2 gm NaOH flasks);
III) ageing the soaked extrudate in the solution obtained at step (II) for 1 hours at a temperature in the range of 25-35° C.;
IV) heating the reaction mixture obtained at step (III) to a temperature in the range of 80-85° C. and maintaining at 80-85° C. for 17 h;
V) cooling the reaction material obtained at step (IV) and decanting the supernatant solution and washing three times with 100 ml of deionized water, filtering and drying at 100° C. (The material produced in this manner exhibits a crystallinity of 95% (XRD) based on the initial zeolite powder).

In another embodiment, the present invention provides a process for the preparation of a Na-LSX zeolite in extrudate form, sphere form, or tablet form, and a binderless Na-LSX zeolite in extrudate form, sphere form, and tablet form by converting binder containing Na-LSX zeolite extrudate/sphere/tablet into binderless zeolite, where said process comprises the steps of:
a. mixing 50 to 90 gm of Zeolite X powder (Na-LSX) as obtained in claim 1, into 10 to 50 gm of a binder as an initial material, and 0.5 to 5 gm of an additive;
b. preparing a dough of proper consistency from the mixture as obtained in step a) in a twin-shaft mixer using 30 to 60 gm of the sodium salt of carboxymethyl cellulose solution with 1 to 10 wt. %;
c. shaping the dough mixture as obtained at step b) subsequently into 0.5 to 10 mm-sized extrudate in a screw extruder Machine;
d. cutting the extrudate as obtained in step c) after extrusion, into a length of 2 to 5 mm, and then, drying at a temperature in the range of 100-120° C. for a time period of 10-14 hrs, followed by annealing at a temperature in the range of 500-650° C. for a time period of 3.5-4.5 hrs to obtain Na-LSX extrudate;
e. processing the Na-LSX extrudate of step d) in a spheronization machine to make it Na-LSX sphere or tablet;
f. soaking the 10 gm to 100 kg of extrudate/sphere/tablet as obtained in any of steps d) or e) in 100 ml to 1000 L of deionized water for time period of 60 min;
g. decanting the water largely after a predetermined time from the reaction material obtained in step f) and replacing with a solution Z comprises of NaOH solution;
h. ageing the soaked extrudate/sphere/tablet of step f) with the solution Z as obtained in step g) for 0.5-1.5 hrs at a temperature in the range of 25-35° C.;
i. heating the reaction mixture as obtained in step h) at a temperature in the range of 80-85° C. for time period of 15-19 hrs; and
j. cooling the reaction mixture obtained in step i), decanting the supernatant solution followed by washing three times with 100 ml of deionized water, and filtering and drying at temperature in the range of 90-110° C. to obtain the binderless Na-LSX zeolite in extrudate form, sphere form, or tablet form.

In preferred embodiment, the amount of Zeolite X powder (Na-LSX) used in step a) is 70 gm. In another preferred embodiment, the amount of binder is 30 gm. In another preferred embodiment, the amount of additive is 2 gm.

In preferred embodiment, the amount of the sodium salt of carboxymethyl cellulose solution is 45 gm with 2.5 wt. %.

In preferred embodiment, the size of extrudate is 1 mm.

In another embodiment, the solution Z is prepared by mixing and stirring 100 ml deionized water with 2 gm of NaOH flasks.

In another embodiment, the binderless Na-LSX zeolite in extrudate/sphere/tablet form exhibitis about 100% crystallinity, measured using powder XRD.

In another embodiment, the binder is selected from kaolin clay, Attapulguide clay, bentonite clay, montmorrilonite clay and/or mixture thereof.

In another embodiment, the additive is selected from lactose, poly acrylic acid, Microcrystalline cellulose, polyvinyl alcohol, polylactic acid and/or mixture thereof.

In another embodiment, the process further comprises treating said binderless Na-LSX zeolite in extrudate/sphere/tablet form with 0.5M CaCl₂ solution for temperature in the range of 90-110° C. for time period of 16-20 hrs to obtain a Ca exchanged binderless Na-LSX zeolite. Optionally, this Ca exchanged binderless Na-LSX zeolite is washed and dried at temperature of 90-110° C. for time period of 10-14 hrs followed by activation at temperature of 420 to 480° C. for time period of 5-7 hrs.

In another embodiment, the process further comprises treating said binderless Na-LSX zeolite in extrudate/sphere/tablet form with 2M LiCl solution for temperature in the range of 85-105° C. for time period of 4 to 6 hrs to obtain a Li exchanged binderless Na-LSX zeolite. Optionally, this Li exchanged binderless Na-LSX zeolite is washed and dried at temperature of 90-110° C. for time period of 10-14 hrs followed by activation at temperature of 380 to 420° C.

In preferred embodiment, zeolite obtained in above processes in the form of extrudates are cylindrical in shape, the sphere is in spherical shape and the tablet is in pellet shape.

In another embodiment, the addition sequence of the aforesaid processes, especially addition of KOH is at the last step is unique and important, which helps to adjust the alkali concentration or pH in the gel and also to get homogeneous gel.

Accordingly, the combination of particular molar gel composition and addition sequence of alkali solution(s), completely eliminated gel ageing, which is required for other molar gel composition (as known in the literature), as well as with the addition of NaOH+KOH together.

In another embodiment, the particular gel composition as disclosed above helps to replace two step crystallization (first step nucleation and second step crystallization) into an one step where nucleation and crystallization happened concurrently in said one step crystallization process.

In another embodiment, the present invention provides a process of adsorption of nitrogen from a sample, comprising:
i) treating said sample comprises of air, oxygen and nitrogen, with said binderless zeolite based on sodium LSX as claimed in any of preceding claims, and
ii) measuring N2 adsorption in a Brunauer-Emmett-Teller (BET) instrument at atmospherice pressure.

In another embodiment, prior to said treating step i), the sample is degassed at a temperature in the range of 300-360 C for a time period of 10-14 hrs.

In a preferred embodiment, prior to said treating step i), the sample is degassed at a temperature of 340° C. for time period of 12 hrs.

Another embodiment of the present invention is that a binderless Na-LSX zeolite is applicable in N2 adsorption measured in Brunauer-Emmett-Teller (BET) instrument at atmospherice pressure by degassing sample at 340C for 12 h.

The zeolite and processes of present invention is compared with the zeolites and processes of prior art documents. The results are summarized below in Table-1:

TABLE 1

| Prior Art (Na-LSX) | | |
|---|---|---|
| (Colloids and Surfaces A | Prior Art (LSX zeolite): | |
| 600 (2020) 124803) | U.S. Pat. No. 9,061,918B2 | Na-LSX of the present work |
| Molar Gel Composition: | Molar Gel Composition: | Molar Gel Composition |
| SiO₂/Al₂O₃ > 3.0; | Na2O/(Na2O + K2O) ratio of | SiO₂/Al₂O₃ = 2.0; |
| (Na₂O + K₂O)/SiO₂ = 3.5; | 0.75 to 1; SiO2/Al2O3 of 1.8 to | (Na₂O + K₂O)/SiO₂ = 3.0; |
| Na₂O/Na₂O + K₂O = 0.77; | 2.2; (Na2O + K2O)/Al2O3, of 4.8 | Na₂O/Na₂O + K₂O = 0.77; |
| H₂O/Na₂O + K₂O = 17 | to 6; H2O/Al2O3 of 60 to 85 | H₂O/Na₂O + K₂O = 25 |
| NaOH + KOH addition | NaOH + KOH addition together | NaOH and KOH addition |
| together | | separately. KOH addition at the |
| | | last after mixing of all other raw |
| | | material |
| Gel Ageing at 50 C. from 4 | Gel ageing at 80 C. for 40 h | No gel ageing |
| to 72 h | | |
| Crystallization in two steps: | Crystallization in two steps: | Crystallization in one step: |
| 80 C. for 3 h and 100 C. for | 80 C. for 40 h and 100 C. for 10 h. | 75° C. for 17 h (100% pure X |
| 2 h (100% Crystallinity) | (higher than 80% crystallinity) | type) |
| Crystallization in one step: | | |
| 70 C. (70% X type and 30% | | |
| A type) | | |
| Binderless Na-LSX: | No binderless treatment | Binderless Na-LSX: NaOH + |
| Addition of sodium | | Water is required to convert |
| silicate + NaOH + Water is | | 30% Kaolin in [zeolite |
| required to convert 30% | | (70%) + kaolin (30%)] |
| Kaolin in [zeolite (70%) + | | extrudates/granules to zeolite |
| kaolin (30%)] | | and make it binderless. No need |
| extrudates/granules to | | to add sodium silicate for |
| zeolite and make it | | binderless treatment process |
| binderless | | steps. |
| N2 adsorption: Max. 9 | No information on N2 | N2 adsorption: 9.64 ml/g |
| ml/g | adsorption. | |

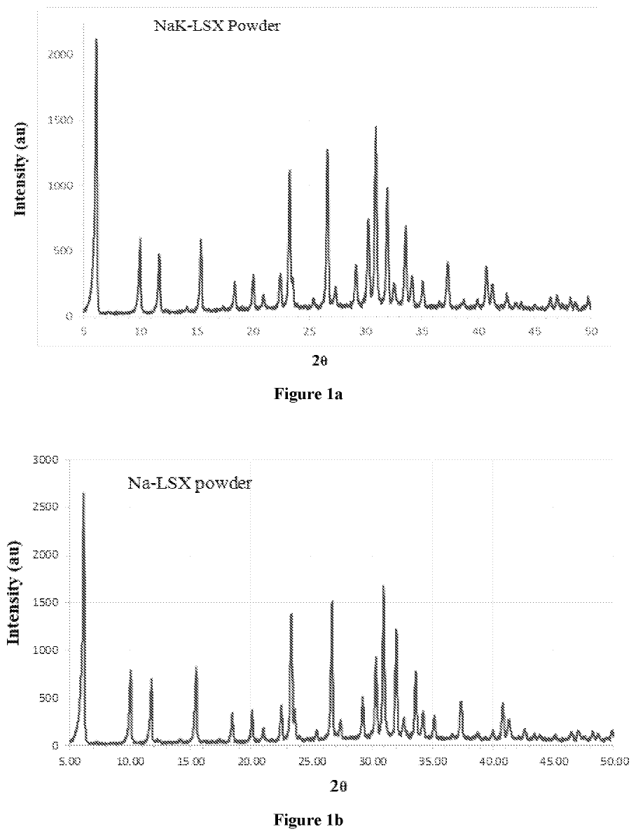

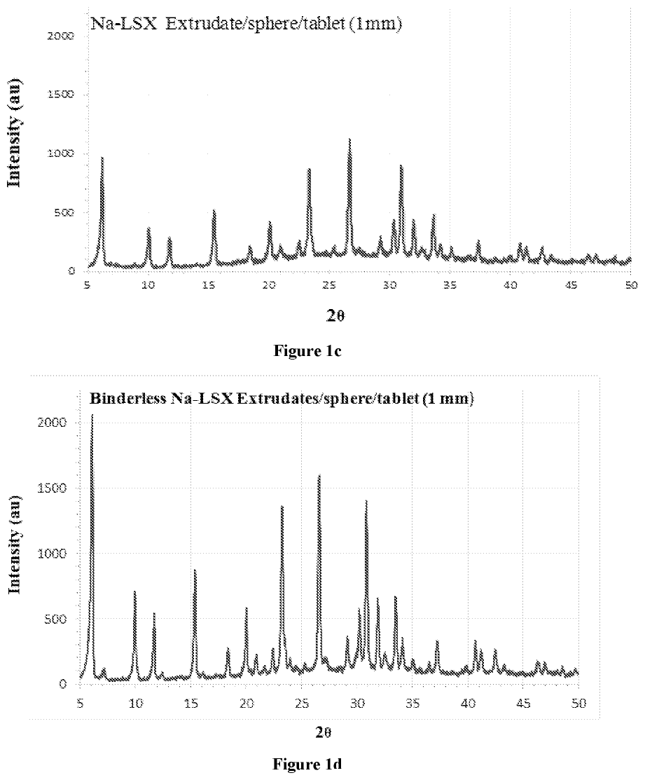

FIG. 1e depicts Powder XRD pattern of the commercial Na-LSX (procured from Arkema Chemical company) and Na-LSX Extrudates of the present invention (FIG. 1d) shows that Na-LSX is more crystalline than the commercial sample.

### EXAMPLES

### Example 1: Synthesis of a NaK LSX Zeolite in Powder Form

Solution A was prepared by dissolving 0.896 kg Sodium aluminate in 2.8L water under continuous stirring and continued stirring till the complete dissolution of Sodium aluminate. Solution B was prepared by dissolving 1.135 kg of NaOH in 4.1 L water under constant stirring. Solution A was added into solution B rapidly under stirring at a temperature in the range of 70-75° C. (temperature of solution B) for a period of 5 minutes. Solution C was prepared by adding sodium silicate solution (2.07 kg) in 4.1 kg water and then solution C was added slowly to a mixture of a solution of A and B under vigorous stirring at a temperature in the range of 30-40° C. for a period of 60 minutes under continuous vigorous stirring. Solution D was prepared by adding 0.878 kg KOH in 0.8 L water and was added into a reaction mixture under vigorous stirring at a temperature in the range of 30-40° C. for a period in the range of 1-2 hour. Obtained gel was transferred into a 20L SS autoclave and crystallized out at 70-75° C. for 17 h. Solid was filtered and washed with demineralized water till Na and K removal and dryed at 100° C. for 12 h.

The powder X-ray figure (FIG. 1a) shows well-resolved diffraction peaks with 100% crystallinity of pure NaK LSX phase, which is the characteristic pattern of faujasite-type zeolite. The chemical analysis result exhibited Si/Al molar ratio of 1.04 to 1.08, corresponding to the Si/Al molar ratio of LSX zeolite.

### Example 2: Conversion of a NaK-LSX to Na-LSX Zeolite in Powder Form

The NaK-LSX thus obtained in Example 1 was further subjected to ion exchange using 2 M Sodium chloride solution (in the proportion of 10 ml per gram of solid) at pH=9-10 at 95° C. for 5 h. Excess salt was washed with deionized water to remove chloride ions from the solid and dried the solid at 110° C. for 12 h to afford Na-LSX.

The powder X-ray figure (FIG. 1b) of Na-LSX also revealed well-resolved diffraction peaks of faujasite-type zeolite with 100% crystallinity of pure Na LSX phase, which indicate that structural properties remained unchanged after the conversion of NaK-LSX to Na-LSX. The 100% crystallinity of synthesized Na-LSX is further confirmed by comparing with commercial Na-LSX powder XRD data (see FIG. 1e), which clearly shows that there is lesser intensity peaks (Y axis) and that to with presence of amorphous powder along with impurities (considering blurred x-axis graph of FIG. 1e). In contrast, the present synthesized binderless Na-LSX is 100% crystalline without impurities considering higher intensity and clear x-ray graph (see FIG. 1b).

### Example 3: The Preparation of a Na-LSX Zeolite in Extrudates, Sphere, and Tablet Form

70 g of Na-LSX of Example of 2 was mixed with 30 g of kaolin (initial material 4) and 2 g of a Lactose. A dough of the above mixture of proper consistency was prepared in a twin-shaft mixer using 45 gm of the sodium salt of carboxymethyl cellulose solution (2.5 wt %). The obtained dough mixture was shaped subsequently into 1 millimetre-sized extrudate in a screw extruder Machine (V J instrument). The mixture was cut after extrusion, into length of 2 to 5 mm, dried at 110° C. for 12 h and then annealed at 600° C. for 4 h.

(The extrudate obteained after extruder in wet form was further processed in spheronization machine to make it sphere or tablet.)

XRD figure (FIG. 1c) of Na-LSX zeolite in extrudate/sphere/tablet form does not show any extra peak due to any impurity. However, the peak intensities of faujasite characteristic peak are lower than parent Na-LSX in powder form. It is apparent that the relative crystallinity is decreased from 100% for Na-LSX in powder form to 31% for Na-LSX zeolite in extrudate/sphere/tablet form. 30% drop crystallinity is due to a 30% contribution of 30% kaolin.

### Example 4: The Preparation of a Binderless Na-LSX Zeolite in Extrudates, Sphere, and Tablet Form

20 g of Na-LSX extrudates of Example 3 was added to 200 ml water and allowed to soak water for 60 min. After 1 hour, decanted excess water and then wet extrudates were added to 200 ml 2% NaOH solution. The mixture was allowed to age for 1 hour at 25-35° C. Finally, the mixture was subjected to hydrothermal treatment at 80-85° C. for 17 h. The extrudate/sphere/tablet was then separated decanting the supernatant solution and washed with 100 ml of deionized water, filtering and drying at 100° C.

Compared with parent Na-LSX in powder form, Na-LSX extrudate/sohere/tablet (FIG. 1d) regained % crystallinity to >95% after binderless treatment. The binderless Na-LSX zeolite in extrudates is comparatively more crystalline than the commercial sample (FIG. 1e).

### Example 5: N₂ Adsorption Measurement of LSX Zeolite

The N₂ adsorption isotherms of Na-LSX, extrudates/sphere/tablet were measured using a static volumetric system (Micromeritics ASAP 2010 system). Prior to the measurement of isotherms, the samples were activated in a vacuum at 340° C. for 8 hrs.

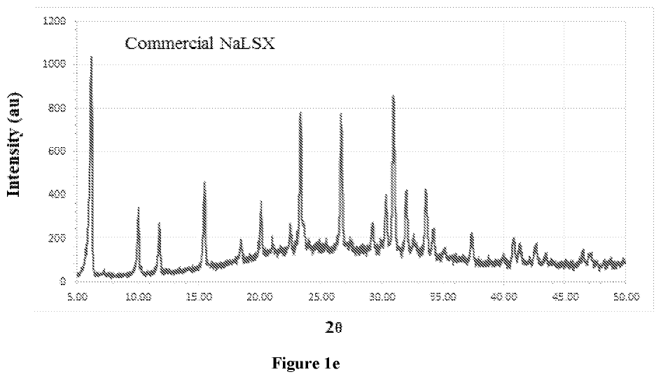

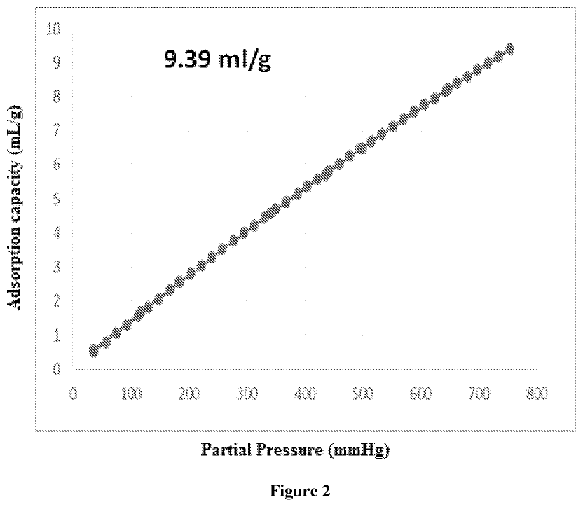

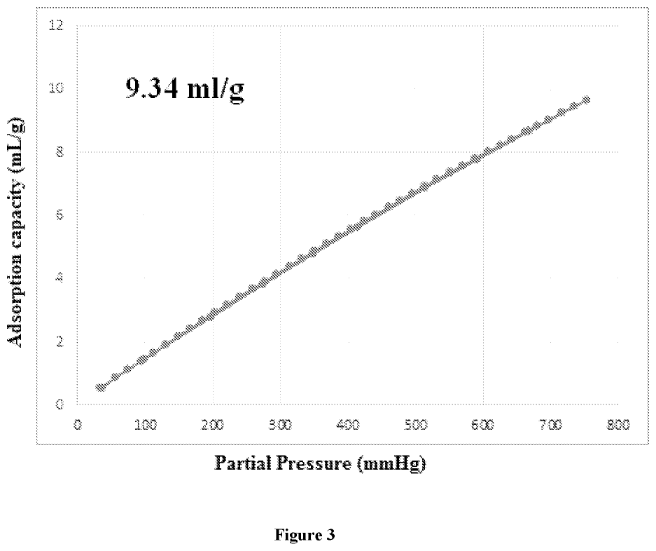

FIG. 2 and FIG. 3 both represent the N2 adsorption isotherms of parent Na-LSX in powder form and binderless Na-LSX in extrudate/sphere/tablet form, measured at room temperature.

N₂ Adsorption of Na-LSX Powder and Binderless Na-LSX Extrudates/sphere/tablet is 9.39 and 9.34 ml/g, respectively. The N₂ uptake of parent Na-LSX and binderless Na-LSX is almost similar.

### Example 6: Ca-Exchange of Binderless Na-LSX Zeolite in Extrudates/Sphere/Tablet

10 gm of Binderless Na-LSX zeolite in extrudates/sphere/tablet prepared in Example 4 is exchanged with Ca in a glass column using a 0.8 ml/min flow of 0.5M CaCl₂ solution for 18 hr at 100° C. After the exchange, the sample was washed till Cl⁻ ion free, dried at 100° C. for 12 hr and activated at 460° C. for 6 hours.

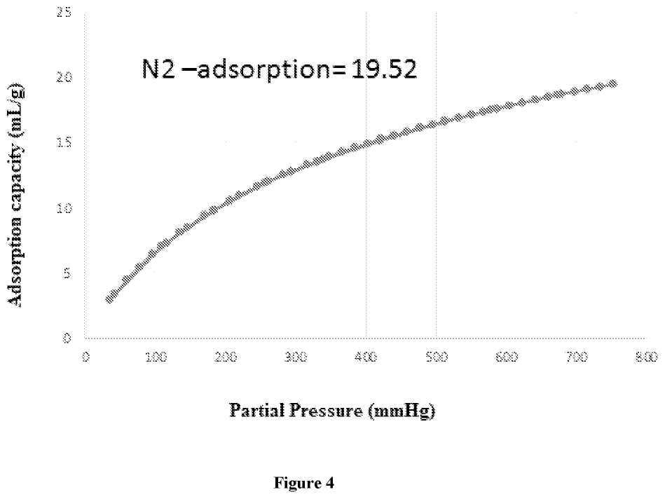

N₂ adsorption isotherms of the Ca Exchanged sample were measured according to Example 5. FIG. 4 indicates the N₂ isotherm of the Ca-exchange sample, the N₂ adsorption capacity is 19.52 ml/g.

### Example 7: Li-Exchange of Binderless Na-LSX Zeolite in Extrudates/Sphere/Tablet

6 gm of Binderless Na-LSX zeolite in extrudates/sphere/tablet prepared in Example 4 is exchanged with Li in a glass column using 0.9 ml/min flow of 2M LiCl solution for 5 hr at 95° C. After the exchange, the sample was washed till Cl⁻ ion free, dried at 100° C. for 12 hr and activated at 400° C.

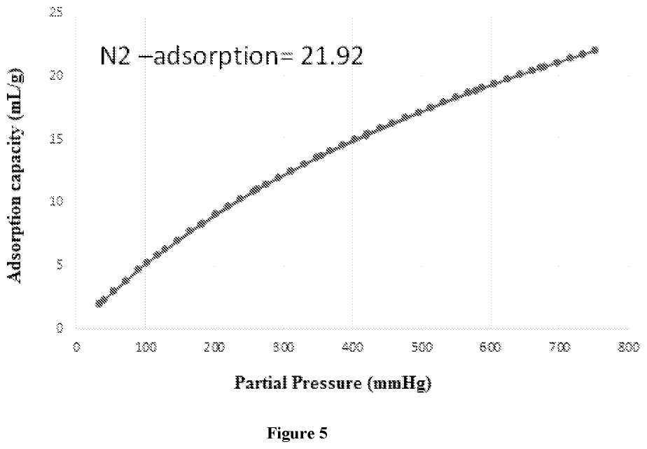

FIG. 5 indicates N₂ absorption of isotherms the Li exchange sample. The N₂ adsorption capacity is 21.92 ml/g.

### Advantages of the Invention

New synthesis process for 13X or Na-LSX zeolite
Highly crystalline Na-LSX with pure phase.
Separate addition of KOH provide better mixing of alkali, improve mixing and crystallization.
higher N₂ adsorption has been obtained with the above prepared Na-LSX.
In binderless process, only NaOH treatment is required whereas literature known methods require NaOH+Sodium aluminate addition.
In the process of preparation of Na-LSX zeolites, the addition of KOH solution (solution D) into mixtures of solution containing solutions A to C is differentiating and not disclosed anywhere in the literature known methods.

1. A binderless zeolite for higher N₂ adsorption, comprising sodium LSX, wherein a molar gel composition of said binderless zeolite comprises SiO₂, Al₂O₃, Na₂O, K₂O, and H₂O with ratio of 1.9:0.9:4.52:1.28:140 to 2.1:1.1:4.72:1.48:150, and wherein a molar concentration of said binderless zeolite comprises SiO₂/Al₂O₃=1.9 to 2.1; (Na₂O+K₂O)/SiO₂=2.9 to 3.1; Na₂O/(Na₂O+K₂O)=0.67 to 0.87; and H2O/(Na₂O+K₂O)=24 to 26.

2. The binderless zeolite as claimed in claim 1, which has a 100% crystallinity of pure 13X phase or NaX phase.

3. A process for the synthesis of the sodium LSX, wherein the sodium LSX is in a powder form, wherein said process comprises the steps of:
(a) preparing a mixture of solution A of sodium aluminate in water and solution B of sodium hydroxide in water;
(b) mixing a solution C of sodium silicate in water with the mixture of solution A and solution B as obtained in step (a);
(c) mixing a solution D of KOH in water with the mixture obtained in step (b) to obtain a gel;
(d) crystallizing the gel obtained in step (c) to obtain a crystallized gel;
(e) removing Na and K from the crystallized gel obtained in step d), and drying the resultant crystallized gel to obtain a first NaK-LSX zeolite in a powder form;
(f) subjecting the first NaK-LSX zeolite in a powder form of step e) for an ion exchange step to obtain an ion exchanged NaK-LSX zeolite; and
(g) drying the ion exchanged NaK-LSX zeolite to obtain a Na-LSX zeolite in a powder form.

4. The process as claimed in claim 3, wherein the solution A is prepared by dissolving 0.5 to 2 kg of sodium aluminate in 2 to 6L of water under continuous stirring of 220-280 rpm till complete dissolution of said sodium aluminate; wherein the solution B is prepared by dissolving a 1.5 to 4 kg of NaOH in 3.5 to 7 L of water under constant stirring of 220-280 rpm at a temperature in the range of 70-75° C.; wherein the solution C is prepared by adding 1.5 to 3 kg of sodium silicate in 3.5 to 7 kg of water under stirring of 220 to 280 rpm; and wherein the solution D is prepared by adding 0.5 to 2 kg of KOH in 0.5 to 3 L of water under stirring of 220 to 280 rpm.

5. The process as claimed in claim 3, wherein the ion exchange step is done using 0.5 to 4 M of sodium chloride solution in the proportion of 10 ml per gram of solid.

6. A process for the preparation of a Na-LSX zeolite in an extrudate form, a sphere form, or a tablet form by converting a binder containing Na-LSX zeolite into binderless zeolite, wherein the Na-LSX zeolite is a binderless Na-LSX zeolite, wherein said process comprises the steps of:
a. mixing a Zeolite X powder (Na-LSX) with a binder, and an additive;
b. preparing a dough from a mixture as obtained in step a) and the sodium salt of carboxymethyl cellulose solution;
c. extruding the dough mixture as obtained at step b) into a plurality of extrudates;
d. cutting the plurality of extrudates as obtained in step c), and annealing to obtain annealed Na-LSX extrudates;
e. spheronizing the annealed Na-LSX extrudates of step d) to obtain Na-LSX sphere or tablet;
f. placing the Na-LSX extrudate/sphere/tablet as obtained in any of steps d) or e) in water;
g. replacing the reaction material in water obtained in step f) with a solution Z comprising of NaOH solution;
h. ageing the resultant Na-LSX extrudate/sphere/tablet of step g);
i. heating the reaction mixture as obtained in step h); and
j. cooling and drying the reaction mixture obtained in step i) to obtain the binderless Na-LSX zeolite in the extrudate form, the sphere form, or the tablet form.

7. The process as claimed in claim 6, wherein the solution Z is prepared by mixing and stirring 100 ml deionized water with 2 gm NaOH flasks; and wherein the binderless Na-LSX zeolite in the extrudate form, the sphere form, or the tablet form exhibits about 100% crystallinity, measured by using powder XRD.

8. The process as claimed in claim 6, wherein the binder is selected from a group consisting of kaolin clay, Attapulguide clay, bentonite clay, montmorrilonite clay or a mixture thereof.

9. The process as claimed in claim 6, further comprising treating said binderless Na-LSX zeolite with CaCl₂ solution to obtain a Ca exchanged binderless Na-LSX zeolite.

10. A process of adsorption of nitrogen from a sample, comprising:
i) treating a sample comprising air, oxygen and nitrogen, with said binderless zeolite based on sodium LSX as claimed in claim 1, and
ii) measuring N₂ adsorption of the treated sample.

11. The process as claimed in claim 10, wherein prior to treating step i), the sample is degassed.

12. The process as claimed in claim 6, wherein the additive is selected from a group consisting of lactose, poly acrylic acid, Microcrystalline cellulose, polyvinyl alcohol, polylactic acid or a mixture thereof.

13. The process as claimed in claim 6, further comprising treating said binderless Na-LSX zeolite with LiCl solution to obtain a Li exchanged binderless Na-LSX zeolite.

14. A process, comprising:
treating a sample comprising air, oxygen and nitrogen, with said binderless zeolite of claim 1.

15. The process as claimed in claim 14, further comprising degassing the sample.

16. The process as claimed in claim 14, further comprising measuring N₂ adsorption of the treated sample.

17. A process, comprising:
treating a sample comprising air, oxygen and nitrogen, with said sodium LSX in a powder form prepared according to claim 3.

18. The process as claimed in claim 17, further comprising degassing the sample.

19. A process, comprising:
treating a sample comprising air, oxygen and nitrogen, with said Na-LSX zeolite in an extrudate form, a sphere form, or a tablet form prepared according to claim 6.

20. The process as claimed in claim 19, further comprising degassing the sample.
